(19) United States
(12) Patent Application Publication
(10) Pub. No.: US 2026/0195158 A1
(43) Pub. Date: Jul. 9, 2026

(54) CONFIDENTIAL MACHINE LEARNING COMPUTING FOR UNTRUSTING PARTIES

(71) Applicant: International Business Machines Corporation, Armonk, NY (US)

(72) Inventors: Zhongshu Gu, YORKTOWN HEIGHTS, NY (US); Md Salman Ahmed, YORKTOWN HEIGHTS, NY (US); Michael Vu Le, YORKTOWN HEIGHTS, NY (US); Julian James Stephen, YORKTOWN HEIGHTS, NY (US); Pau-Chen Cheng, YORKTOWN HEIGHTS, NY (US); Enriquillo Valdez, YORKTOWN HEIGHTS, NY (US); Hani Talal Jamjoom, YORKTOWN HEIGHTS, NY (US)

(21) Appl. No.: 19/008,968

(22) Filed: Jan. 3, 2025

(51) Int. Cl. G06F 9/455; H04L 9/40

(52) U.S. Cl. CPC G06F 9/45558; H04L 63/02; G06F 2009/45575; G06F 2009/45587; G06F 2009/45595

(57) ABSTRACT

An example operation includes one or more of booting a confidential VM based on a predefined image in response to a request from a software application, and disabling network communications into and out of the confidential VM, mounting an encrypted disk inside the confidential VM based on the predefined image, importing an encrypted ML model into the confidential VM based on the request from the software application, importing a decryption key into the confidential VM and decrypting the encrypted ML model inside the confidential VM based on the decryption key, importing a second decryption key into the confidential VM and decrypting the encrypted disk inside the confidential VM, and launching a machine learning service with an executable instance of the encrypted ML model inside the confidential VM with an interface that enables the software application to input data to the executable instance of the encrypted ML model.

### BACKGROUND

Machine learning (ML) model providers may provide their models to a host platform, such as a cloud platform, where their models can be accessed. A data owner may then upload their data, which may be confidential, for processing by the ML model. During this process, proprietary data of the ML model may be accessible to the data owner and the data of the data owner may be accessible to the model provider. Furthermore, when the machine learning platform is hosted by a third-party that is independent from the model provider and the data owner, an additional party, which may not be verified or trusted, may have access to the data of the data owner and the proprietary data of the ML model.

### SUMMARY

One example embodiment provides a method that may include one or more of booting a confidential virtual machine (VM) based on a predefined image in response to a request from a software application, and disabling network communications into and out of the confidential VM, importing an encrypted machine learning (ML) model into the confidential VM based on the request from the software application, importing a decryption key into the confidential VM and decrypting the encrypted ML model inside the confidential VM based on the decryption key, and launching a machine learning service with an executable instance of the encrypted ML model inside the confidential VM with an interface that enables the software application to input data to the executable instance of the encrypted ML model.

Another example embodiment provides a computer system that may include a processor set, a set of one or more computer-readable storage media, and program instructions, collectively stored in the set of one or more storage media, that cause the processor set to perform computer operations that may include one or more of booting a confidential virtual machine (VM) based on a predefined image in response to a request from a software application, and disabling network communications into and out of the confidential VM, importing an encrypted machine learning (ML) model into the confidential VM based on the request from the software application, importing a decryption key into the confidential VM and decrypting the encrypted ML model inside the confidential VM based on the decryption key, and launching a machine learning service with an executable instance of the encrypted ML model inside the confidential VM with an interface that enables the software application to input data to the executable instance of the encrypted ML model.

A further example embodiment provides a computer program product that may include a set of one or more computer-readable storage media, and program instructions, collectively stored in the set of one or more computer-readable storage media, for causing a processor set to perform computer operations that may include one of more of booting a confidential virtual machine (VM) based on a predefined image in response to a request from a software application, and disabling network communications into and out of the confidential VM, importing an encrypted machine learning (ML) model into the confidential VM based on the request from the software application, importing a decryption key into the confidential VM and decrypting the encrypted ML model inside the confidential VM based on the decryption key, and launching a machine learning service with an executable instance of the encrypted ML model inside the confidential VM with an interface that enables the software application to input data to the executable instance of the encrypted ML model.

### BRIEF DESCRIPTION OF THE DRAWINGS

FIG. 1 is a diagram illustrating a computing environment according to an embodiment of the instant solution.

FIG. 2 is a diagram illustrating a confidential computing environment for machine learning according to examples and features of the instant solution.

FIG. 3A is a diagram illustrating a process of booting a confidential virtual machine and contents thereof according to examples and features of the instant solution.

FIG. 3B is a diagram illustrating a process of importing an encrypted machine learning model and a decryption key into the confidential VM according to examples and features of the instant solution.

FIG. 3C is a diagram illustrating a process of launching a machine learning service and an interface according to examples and features of the instant solution.

FIG. 3D is a diagram illustrating a process of disabling network access to the confidential VM according to examples and features of the instant solution.

FIG. 3E is a diagram illustrating a process of generating an encrypted channel between a data provider and the machine learning service in the confidential VM according to examples and features of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

Traditionally, fully homomorphic encryption (FHE) may be used to protect input data for machine learning inference/training. In this approach, the data owner encrypts their data and provisions the encrypted data to the service provider. The provider uses an FHE scheme to run inference/training against a machine learning model. The service provider cannot access the original input data as they are encrypted during the computation. While this process is significantly time-consuming because FHE is computationally expensive and only supports a limited set of operations. In addition, if we want to further protect both the model and data confidentiality, another cryptographic technique, such as multi-party computation, needs to be employed to prevent the leakage of model parameters.

The example embodiments are directed to a process which instantiates a confidential computing environment for a machine learning model/service without the need for fully homomorphic encryption. Instead, the computing environment is managed using a confidential virtual machine (VM) which enforces runtime protection and access control while the data/model are in use. Furthermore, an ML model may be encrypted outside of the confidential VM and then decrypted inside the confidential VM thereby limiting exposure of the ML model and its proprietary data.

Furthermore, an encrypted communication channel may be established between a data owner node and an interface of the confidential VM. The encrypted channel ensures that the data from the data owner node is not revealed until it is inside the confidential VM. Network communications into the confidential VM (i.e., ingress) and network communications out of the confidential VM (i.e., egress) may be disabled preventing all other communications into and out of the confidential VM other than through the interface. The interface may also be restricted such that it only allows the data owner node to upload data and receive results from the output of the ML model running inside the confidential VM.

Some of the benefits of the example embodiments include preventing proprietary data of the ML model from being leaked or otherwise revealed to the data owner and preventing sensitive data of the data owner node from being accessible to the model provider and also the service provider of the host platform. Furthermore, the ML model may operate on unencrypted data thereby improving the speed in which the model computation is performed and the accuracy with which the model computation is performed in comparison to a model that is subjected to fully homomorphic encryption.

The confidential AI computing system described herein may be integrated within a software application, a service, or the like, which may be hosted by a host platform such as a cloud platform, a web server, a database, or the like.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

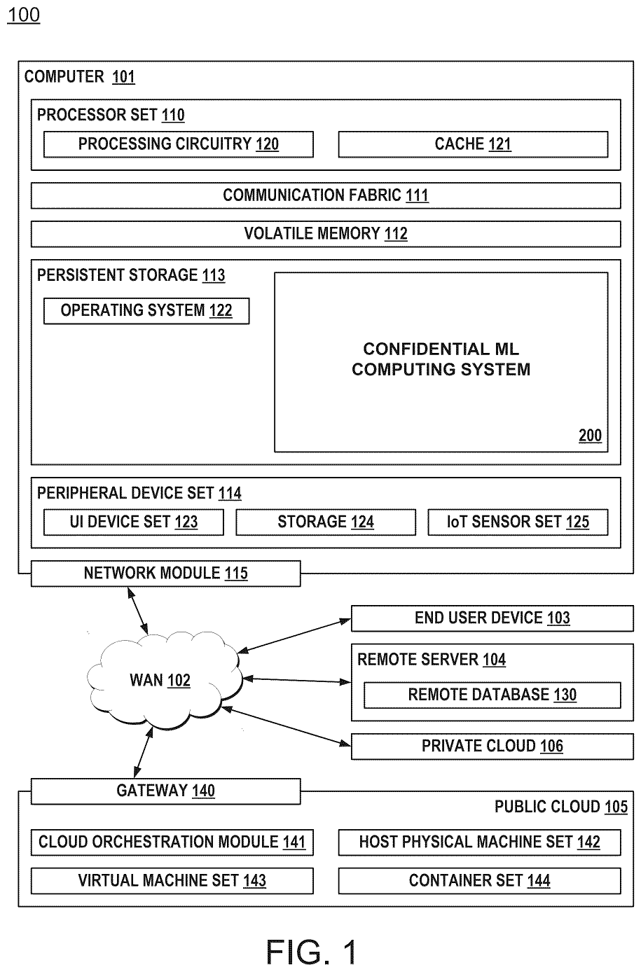

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as confidential ML computing system 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

CLOUD COMPUTING SERVICES AND/OR MICROSERVICES (not separately shown in FIG. 1) private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Developers of machine learning (ML) models, also referred to herein as model providers, may generate machine learning models and publish the models on publicly-available platforms where consumers can access the ML models and use the ML models with their own data. In some cases, the consumers may download the ML model and host it locally on their premises, or they may use the model where it is hosted (e.g., in the cloud, etc.)

Some of the drawbacks of this system include the exposure of both the consumer's data which is often sensitive data, protected data, confidential data, etc., that is held by the consumer, and exposure of the unique content of the ML model which the consumer must access in order to perform inference, training, or the like. For example, the unique content of the ML model may include proprietary data such as model parameters and hyperparameters which can be stolen by and used to recreate the ML model in an unauthorized manner. Thus, the consumers (or data providers) and the model providers are often mutually distrusting parties. Furthermore, when the host platform where the ML models are hosted is controlled by a third-party service provider, such as a cloud provider, the third-party service provider is also a distrusted party.

Related systems which attempt to create a confidential computing environment for machine learning systems rely on fully homomorphic encryption (FHE). FHE is a type of encryption that allows models, such as ML models, to perform computations on encrypted data without ever revealing the plain text of the encrypted data. However, the use of FHE significantly slows down the computation time of the ML models. As a result, the execution of the ML models can take significantly longer, and require significantly more bandwidth and resources from the host platform.

The example embodiments are directed to a confidential computing system that enables ML models to be used by consumers/data owners without leaking sensitive model data to the data owners, and at the same time preventing a model owner from accessing the consumer's sensitive proprietary data. Thus, the system ensures the confidentiality and integrity of the consumer's data, the parameters and hyperparameters of the model, and any computations performed. Furthermore, the system can also be used to protect additional computing resources that are often relied on by ML models such as CPUs and GPUs.

The system provides a confidential virtual machine (VM) and a protective layer such as a network firewall around the confidential VM to provide complete protection and prevent access to the confidential VM other than through a front-end interface, such as an application programming interface (API). The interface may be designed to only allow for data to be input to the confidential VM and predictive results generated by the ML model to be output through the interface. Thus, a consumer is able to provide their data, prompts, etc., and receive a predictive output, but is otherwise unable to access details about the model, etc. The system may also encrypt memory and disks inside the confidential VM thereby preventing client data, the ML model, prompts, answers, etc., from being exposed. The interface is the only mechanism by which the content inside the confidential VM can be accessed. In other words, network communications through other means such as ports, etc., may be disabled by the network firewall.

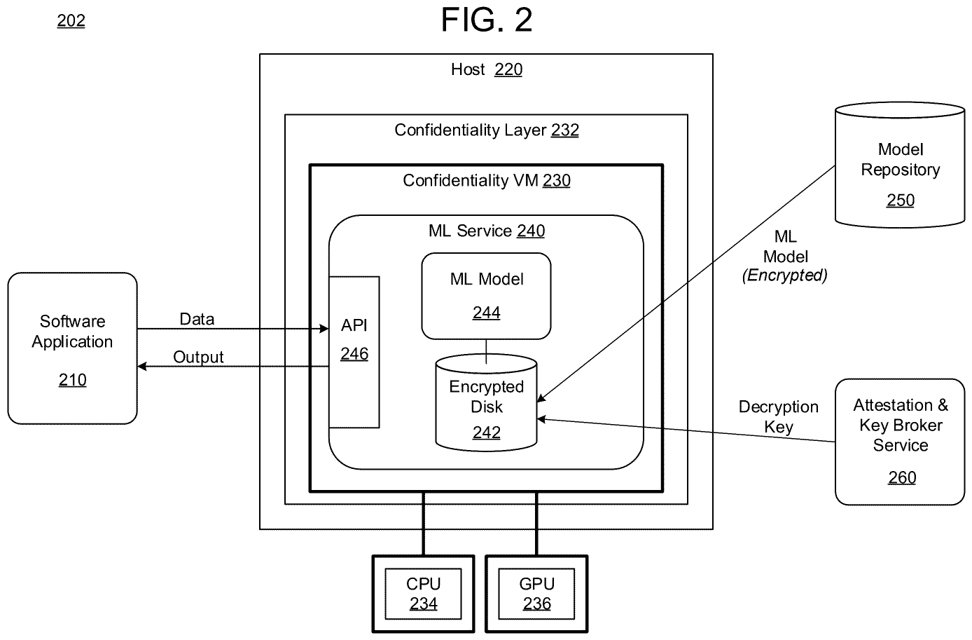

FIG. 2 illustrates a confidential computing environment 202 for machine learning according to examples and features of the instant solution. Referring to FIG. 2, a host platform 220 may host a confidential computing system for protection of data and models for use with machine learning, artificial intelligence, and the like. The host platform 220 may include a cloud platform, a web server, a distributed system, an on-premises server, or the like. In this example, the host platform 220 may generate a secure/confidential computing environment for a machine learning (ML) model 244.

In this example, the host platform 220 instantiates a confidentiality VM 230 for a particular consumer. The confidentiality VM 230 may be specific to the particular consumer. The ML model 244 may be imported into the confidentiality VM 230 from a model repository 250. The ML model 244 may be encrypted thereby preventing leakage of the model content while being imported into the confidentiality VM 230. Inside the confidential VM is an encrypted disk 242 where the ML model 244 can be stored. An attestation and key broker service 260 may provide decryption keys to the confidentiality VM 230 enabling the ML model 244, which is encrypted, to be decrypted. Here, the attestation service may verify an attestation report from the confidentiality VM 230 which contains the necessary services and hardware to implement the confidential computing system and the key broker server provides keys based on the attestation results.

According to various embodiments, the consumer may access the confidentiality VM 230 through a software application 210. The confidentiality VM 230 may host an instance of the ML model 244 within the ML model service 240. The ML model service 240 may also include an interface such as an API 246 which manages access to the ML model 244 by the software application 210. The encrypted disk 242 may store the data and model provisioned by different parties. The disk encryption key may be provisioned by the attestation and key broker service 260 after verifying the attestation report and may be used to decrypt the encrypted disk. The data and model that are held therein can be encrypted with a different key which may be controlled by different parties and decrypted using a different decryption key. These keys may also be provided via the key broker service on demand. For example, if the consumer provides input data from the software application 210 to the confidentiality VM 230, the input data can be encrypted and held in the encrypted disk 242. Also, the data as the input to the ML model 244 may be decrypted and loaded into the memory, thereby enabling the ML model 244 to generate a predictive output.

In some embodiments, the ML model 244 may also rely on at least one of a CPU 234 and a GPU 236 during execution of the ML model 244 on the input data. Here, the confidentiality VM 230 may include a confidentiality layer 232, such as a firewall, which may be launched outside of the confidentiality VM 230 and which prevents network communications from ingress into the confidentiality VM 230 and from egress out of the confidentiality VM 230. The CPU 234 and the GPU 236 are only accessible by the confidentiality VM 230 due to isolation which is enforced by hardware-assisted virtualization.

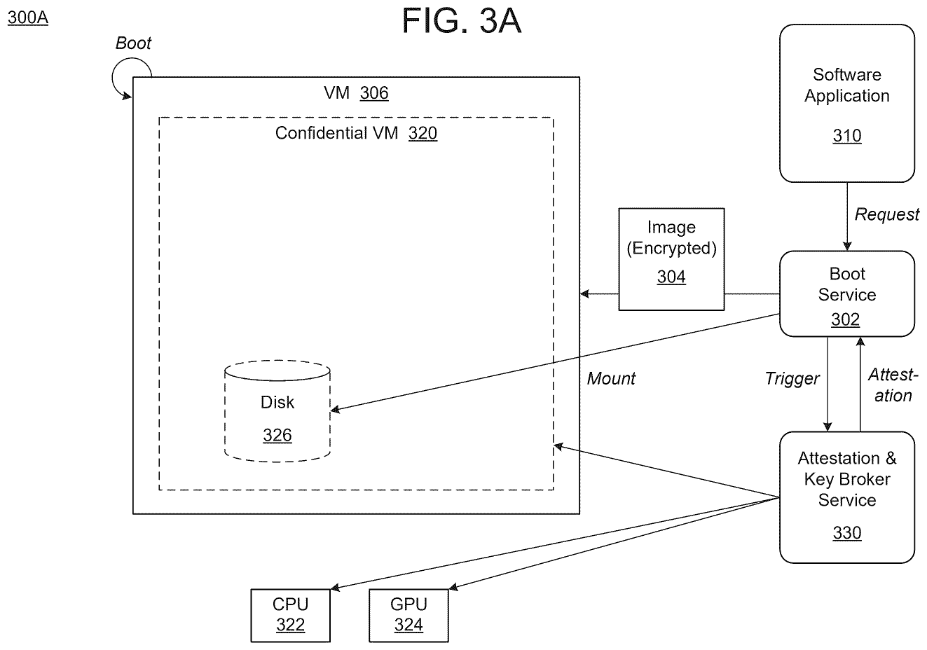

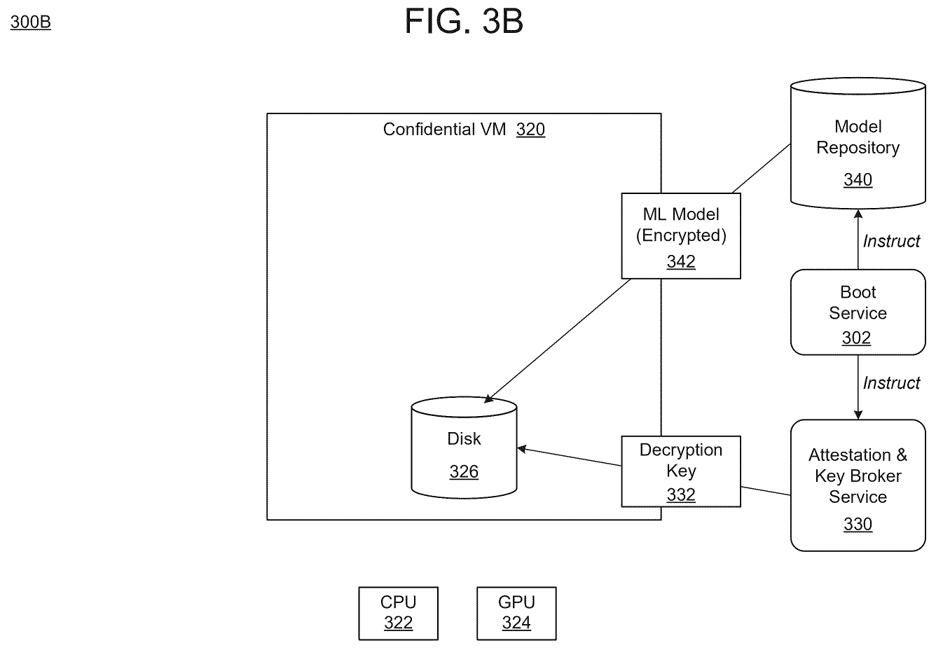

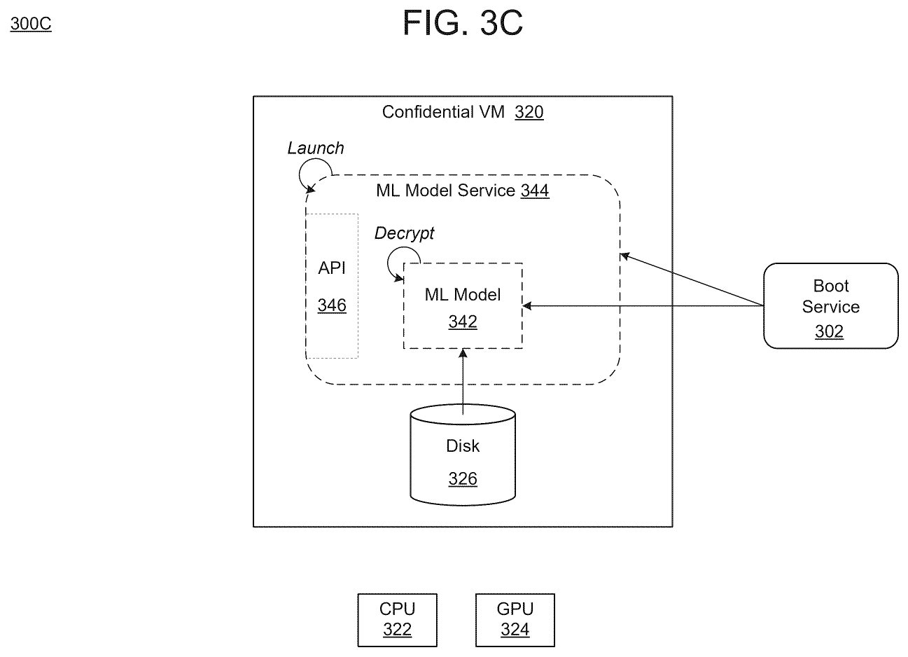

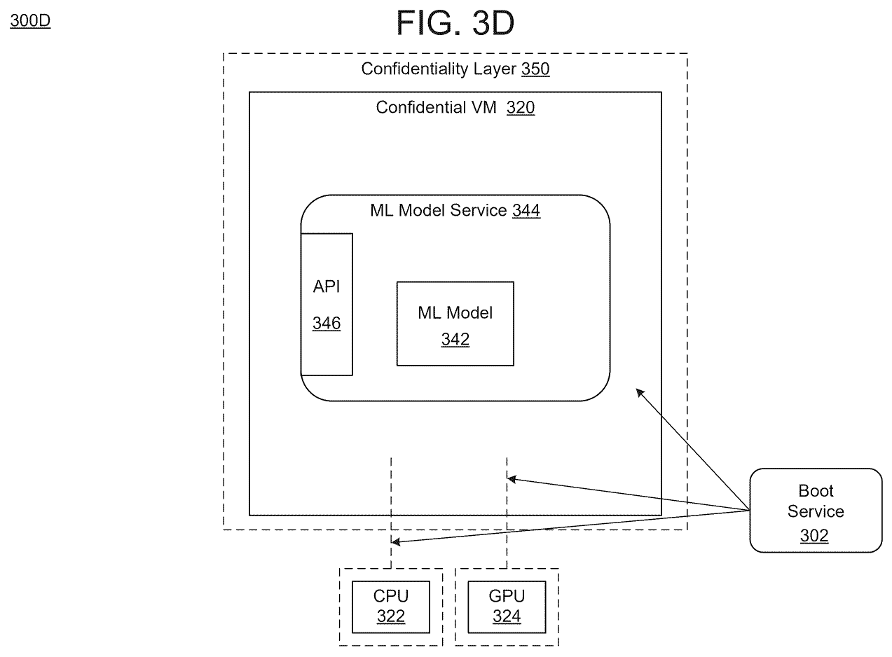

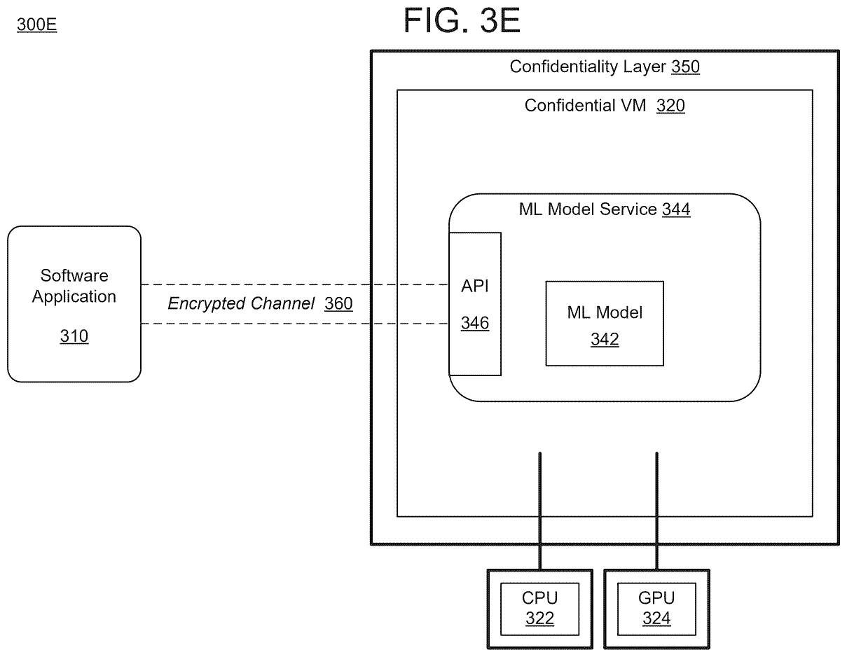

FIGS. 3A-3E illustrate a process of deploying the confidential computing environment for machine learning that is described with respect to FIG. 2. The process shown includes steps used by the host, including a boot service, to ensure that the confidentiality of the computing environment is established before enabling the software application to connect to the confidential VM of the confidential computing environment.

FIG. 3A illustrates a process 300A of booting a confidential virtual machine and contents thereof according to examples and features of the instant solution. Referring to FIG. 3A, a software application 310 may request instantiation of a confidential computing environment from a boot service 302. For example, a command may be entered by a user via a graphical user interface (GUI) of the software application 310. As another example, the request for instantiation may be triggered automatically, for example, in response to a particular condition occurring such as a point in time, or the like. In response to receiving the request, the boot service 302 may provide an image 304 of a confidential virtual machine (VM) to a virtual machine 306. In response, the virtual machine 306 may boot a confidential VM 320 based on a predefined image 304. The confidential VM 320 may utilize hardware-based encryption to protect sensitive data while its being processed in memory.

In addition, the confidential VM 320 may also have access to a CPU 322 and a GPU 324 which may be hosted by the host platform where the confidential VM 320 is hosted, or another system, node, etc. which is accessible to the host platform. In addition, the boot service 302 may also query an attestation and key broker service 330. In response to receiving the request from the boot service 302, the attestation and key broker service 330 may verify the content within the confidential VM 320 matches certain confidentiality standards, requirements, etc. For example, the attestation and key broker service 330 may verify that the confidential VM 320 is using confidential computing (CC)-enabled hardware, and that the CPU 322 and the GPU 324 adhere to certain hardware requirements, and the like.

The attestation and key broker service 330 may notify the boot service 302 of a successful or unsuccessful verification. In this example, the attestation broker verifies/confirms a successful boot of a confidential VM 320 and CC-enabled hardware, and notifies the boot service 302 of the successful verification. In response, the boot service 302 may mount an encrypted disk 326 with a disk decryption key provided by the attestation and key broker service 330 based on the predefined image 304.

FIG. 3B illustrates a process 300B of importing an encrypted machine learning model 342 and a decryption key 332 into the confidential VM 320 according to examples and features of the instant solution. Referring to FIG. 3B, the boot service 302 may continue to boot the remainder of the contents of the confidential VM 320 in an automated manner. For example, after instantiating the encrypted disk 326, the boot service 302 may instruct a model repository 340 to transfer a ML model 342, which is encrypted, to the encrypted disk 326 within the confidential VM 320. In addition, the boot service 302 may also instruct the attestation and key broker service 330 to provide a model decryption key 332 for decrypting the ML model 342. Here, the attestation and key broker service 330 may only release the model decryption key 332 after successfully verifying that the confidential VM 320 adheres to security protocols for confidentiality including encrypted hardware.

FIG. 3C illustrates a process 300C of launching a machine learning service and an interface according to examples and features of the instant solution. Referring to FIG. 3C, the boot service 302 may trigger the confidential VM 320 to decrypt the encrypted ML model 342 using the model decryption key 332. The decrypted version of the ML model 342 may be loaded into a ML model service 344 and instantiated within/inside the confidential VM 320. The ML model service 344 may include a pipeline of nodes including the ML model 342, and other components for example, a tokenizer, an embedding module, a data ingesting module, a rendering module, or the like.

Furthermore, the ML model service 344 may include an API 346 which limits/restricts access to the confidential VM 320. For example, the API 346 may restrict access to enable only input data to be uploaded to execute the ML model 342, and outputs from the ML model 342 to be returned to the software that uploaded the input data. Other network communications may be prevented or otherwise disabled. Therefore, the API 346 may be the only interface which provides access to the ML model 342.

FIG. 3D illustrates a process 300D of disabling network access to the confidential VM according to examples and features of the instant solution. Referring to FIG. 3D, the virtual machine 306 may install a confidentiality layer 350 around the ML model service 344 within the confidential VM 320, which prevents network communications from ingress into the confidential VM 320 and which prevents network communications from egress out of the confidential VM 320. The confidentiality layer 350 may be implemented and deployed in different ways depending on where the confidential VM 320 is being hosted.

For example, if the confidential VM 320 is being hosted on a local/on-premises server, the virtual machine 306 may disable the network communications at a gateway between a cloud platform where the virtual machine 306 resides, and the confidential VM 320 on the on-premises server where the confidential VM 320 is hosted. Here, the virtual machine 306 may create the confidentiality layer 350 by disabling network communications from being sent from the gateway into the confidential VM 320, the CPU 322, and the GPU 324, and thereby prevent network communications from accessing the ML model 342, the ML model service 344, the CPU 322, and the GPU 324. The gateway may also be configured to prevent network communications from leaving the confidential VM 320, the CPU 322, and the GPU 324, for other systems outside of the confidential VM 320.

As another example, if the confidential VM 320 is also being hosted at the platform provider (e.g., on the cloud, etc.), the confidentiality layer 350 may be bootstrapped inside the confidential VM 320 and can install a firewall around (e.g., outside of, etc.) the confidential VM 320, the CPU 322, and the GPU 324, thereby preventing network communications from access to the confidential VM 320, the CPU 322, and the GPU 324. For example, the firewall may disable all other ports and means of ingress and egress besides the API 346.

FIG. 3E illustrates a process 300E of generating an encrypted channel 360 between a data provider (e.g., the software application 310, etc.) and the ML model service 344 inside the confidential VM 320 according to examples and features of the instant solution. Referring to FIG. 3E, a symmetric key pair may be generated by the software application 310 based on a network protocol and the software application 310 may provide the ML model service 344 with a public key from the symmetric key pair and the software application 310 with a private key of the symmetric key pair. The private key may be used by the software application 310 to encrypt communications that are sent to the ML model service 344 thereby ensuring that the data uploaded by the software application remains hidden until it is inside the confidential VM 320.

During live operation, the software application 310 may be used to upload sensitive data (e.g., data owner data) to the confidential VM 320 via the API 346 using the encrypted channel 360. After the sensitive data is inside the confidential VM 320, the sensitive data may be stored in the encrypted disk and accessed only during runtime of the ML model 342. The ML model 342 may ingest the data and generate an output which is then provided to the software application 310 via the API 346.

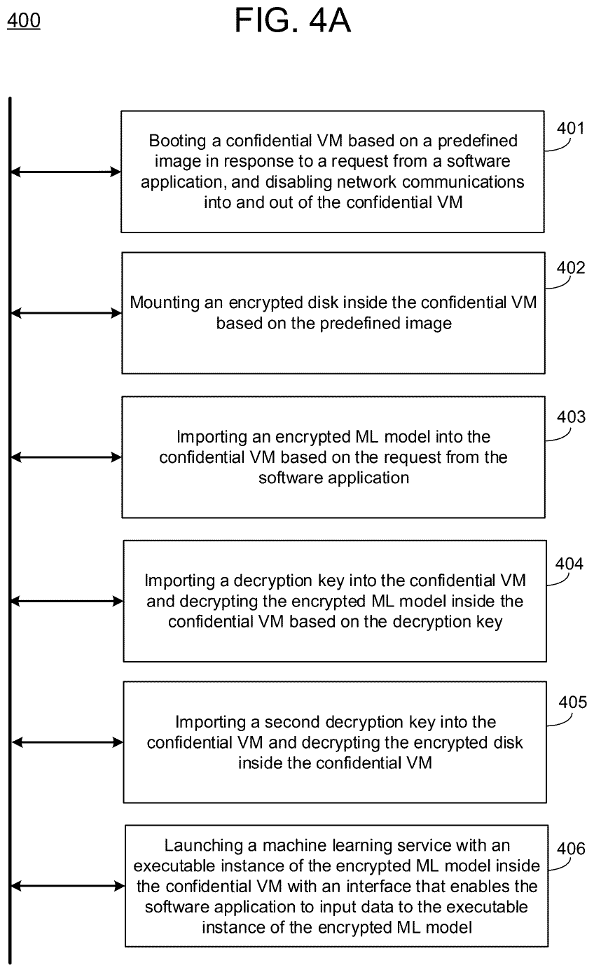

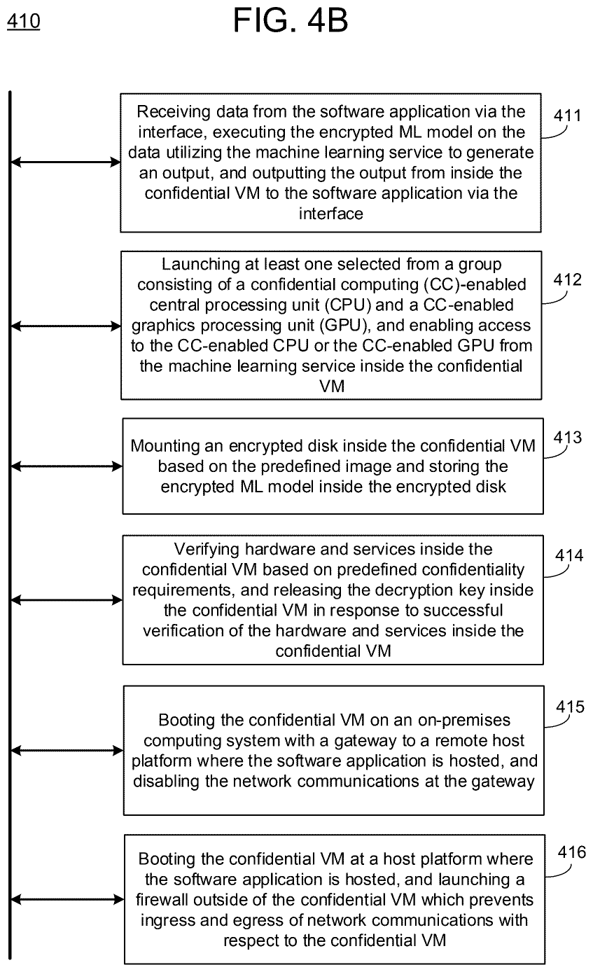

FIG. 4A illustrates a flow diagram of a method 400, according to example embodiments. Referring to FIG. 4A, in 401, the method may include booting a confidential VM based on a predefined image in response to a request from a software application, and disabling network communications into and out of the confidential VM. In 402, the method may include mounting an encrypted disk inside the confidential VM based on the predefined image. In 403, the method may include importing an encrypted ML model into the confidential VM based on the request from the software application. In 404, the method may include importing a decryption key into the confidential VM and decrypting the encrypted ML model inside the confidential VM based on the decryption key. In 405, the method may include importing a second decryption key into the confidential VM and decrypting the encrypted disk inside the confidential VM. In 406, the method may include launching a machine learning service with an executable instance of the encrypted ML model inside the confidential VM with an interface that enables the software application to input data to the executable instance of the encrypted ML model.

FIG. 4B illustrates a flow diagram of a method 410, according to example embodiments. Referring to FIG. 4B, in 411, the method may include receiving data from the software application via the interface, executing the encrypted ML model on the data utilizing the machine learning service to generate an output, and outputting the output from inside the confidential VM to the software application via the interface. In 412, the method may include launching at least one selected from a group consisting of a confidential computing (CC)-enabled central processing unit (CPU) and a CC-enabled graphics processing unit (GPU), and enabling access to the CC-enabled CPU or the CC-enabled GPU from the machine learning service inside the confidential VM. In 413, the method may include mounting an encrypted disk inside the confidential VM based on the predefined image and storing the encrypted ML model inside the encrypted disk.

In 414, the method may include verifying hardware and services inside the confidential VM based on predefined confidentiality requirements, and releasing the decryption key inside the confidential VM in response to successful verification of the hardware and services inside the confidential VM. In 415, the method may include booting the confidential VM on an on-premises computing system with a gateway to a remote host platform where the software application is hosted, and disabling the network communications at the gateway. In 416, the method may include booting the confidential VM at a host platform where the software application is hosted, and launching a firewall outside of the confidential VM which prevents ingress and egress of network communications with respect to the confidential VM.

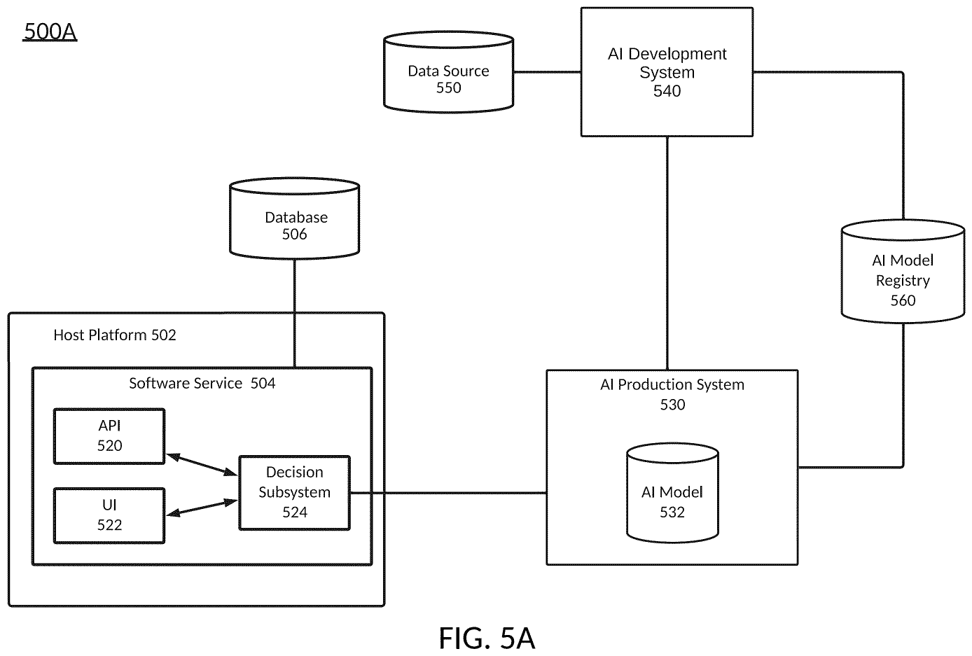

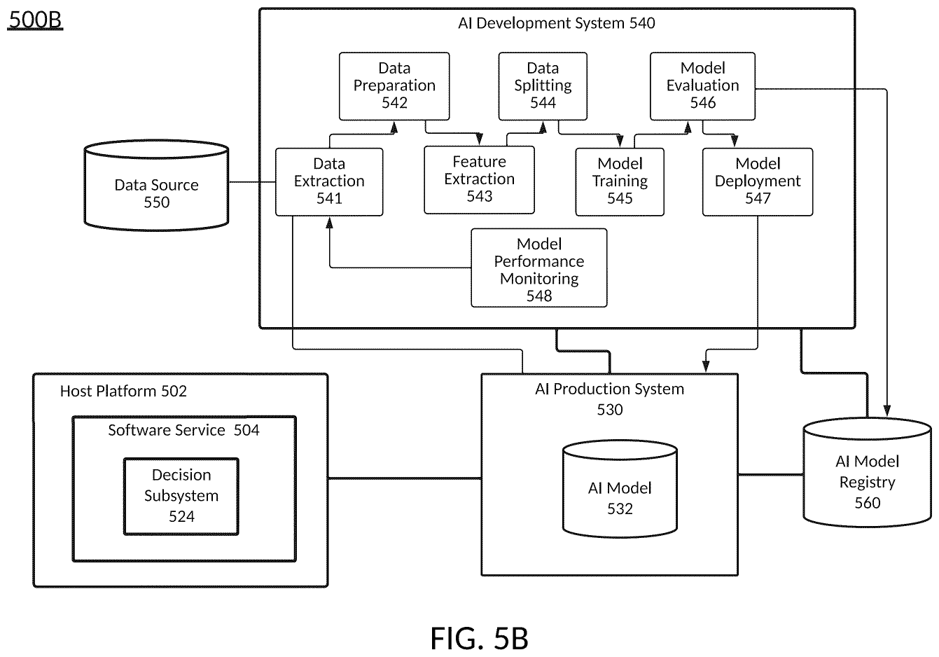

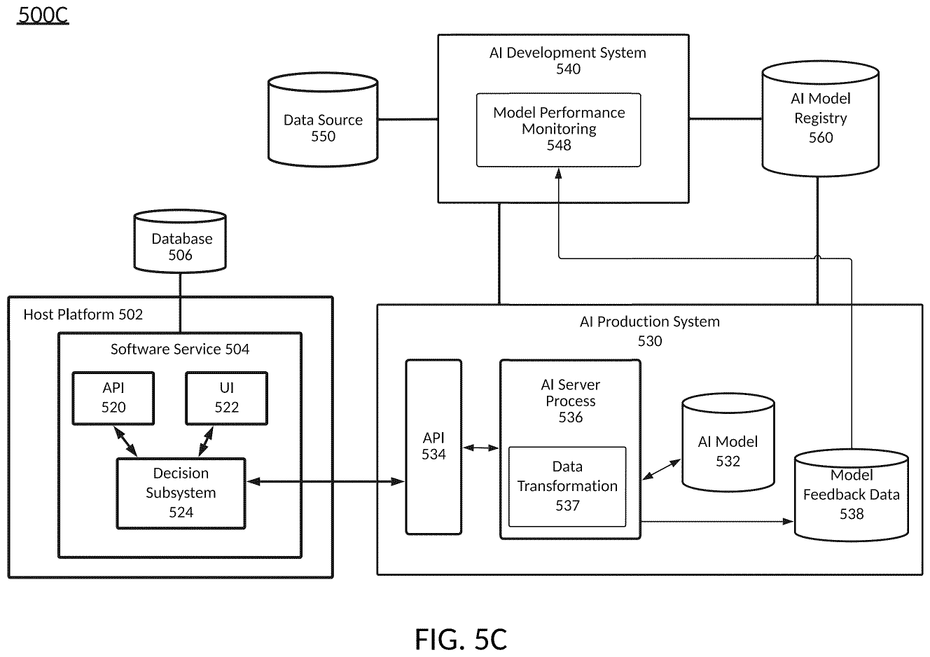

Detailed descriptions of training a machine learning model and executing a machine learning model are further described and depicted herein. The training and execution of the machine learning model described in the examples of FIGS. 5A-5C may be performed inside a confidential machine learning computing environment as described in the examples herein.

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content - such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
booting a confidential virtual machine (VM) based on a predefined image in response to a request from a software application, and disabling network communications into and out of the confidential VM;
mounting an encrypted disk inside the confidential VM based on the predefined image;
importing an encrypted machine learning (ML) model into the confidential VM based on the request from the software application;
importing a decryption key into the confidential VM and decrypting the encrypted ML model inside the confidential VM based on the decryption key;
importing a second decryption key into the confidential VM and decrypting the encrypted disk inside the confidential VM; and
launching a machine learning service with an executable instance of the encrypted ML model inside the confidential VM with an interface that enables the software application to input data to the executable instance of the encrypted ML model.

2. The method of claim 1, further comprising receiving data from the software application via the interface, executing the encrypted ML model on the data utilizing the machine learning service to generate an output, and outputting the output from inside the confidential VM to the software application via the interface.

3. The method of claim 1, wherein the booting comprises launching at least one selected from a group consisting of a confidential computing (CC)-enabled central processing unit (CPU) and a CC-enabled graphics processing unit (GPU), and enabling access to the CC-enabled CPU or the CC-enabled GPU from the machine learning service inside the confidential VM.

4. The method of claim 1, further comprising mounting the encrypted disk inside the confidential VM based on the predefined image and storing the encrypted ML model inside the encrypted disk.

5. The method of claim 4, further comprising verifying hardware and services inside the confidential VM based on predefined confidentiality requirements, wherein the importing the decryption key comprises releasing the decryption key inside the confidential VM in response to successful verification of the hardware and services inside the confidential VM.

6. The method of claim 1, wherein the booting comprises booting the confidential VM on an on-premises computing system with a gateway to a remote host platform where the software application is hosted, and the disabling the network communications comprises disabling the network communications at the gateway.

7. The method of claim 1, wherein the booting comprises booting the confidential VM at a host platform where the software application is hosted, and the disabling the network communications comprises launching a firewall outside of the confidential VM which prevents ingress and egress of network communications with respect to the confidential VM.

8. A computer system comprising:
a processor set;
a set of one or more computer-readable storage media; and
program instructions, collectively stored in the set of one or more storage media, that cause the processor set to perform computer operations comprising:
booting a confidential virtual machine (VM) based on a predefined image in response to a request from a software application, and disabling network communications into and out of the confidential VM;
mounting an encrypted disk inside the confidential VM based on the predefined image;
importing an encrypted machine learning (ML) model into the confidential VM based on the request from the software application;
importing a decryption key into the confidential VM and decrypting the encrypted ML model inside the confidential VM based on the decryption key;
importing a second decryption key into the confidential VM and decrypting the encrypted disk inside the confidential VM; and
launching a machine learning service with an executable instance of the encrypted ML model inside the confidential VM with an interface that enables the software application to input data to the executable instance of the encrypted ML model.

9. The computer system of claim 8, wherein the computer operations further comprise receiving data from the software application via the interface, executing the encrypted ML model on the data utilizing the machine learning service to generate an output, and outputting the output from inside the confidential VM to the software application via the interface.

10. The computer system of claim 8, wherein the booting comprises launching at least one selected from a group consisting of a confidential computing (CC)-enabled central processing unit (CPU) and a CC-enabled graphics processing unit (GPU), and enabling access to the CC-enabled CPU or the CC-enabled GPU from the machine learning service inside the confidential VM.

11. The computer system of claim 8, further comprising mounting the encrypted disk inside the confidential VM based on the predefined image and storing the encrypted ML model inside the encrypted disk.

12. The computer system of claim 11, wherein the computer operations further comprise verifying hardware and services inside the confidential VM based on predefined confidentiality requirements, wherein the importing the decryption key comprises releasing the decryption key inside the confidential VM in response to successful verification of the hardware and services inside the confidential VM.

13. The computer system of claim 8, wherein the booting comprises booting the confidential VM on an on-premises computing system with a gateway to a remote host platform where the software application is hosted, and the disabling the network communications comprises disabling the network communications at the gateway.

14. The computer system of claim 8, wherein the booting comprises booting the confidential VM at a host platform where the software application is hosted, and the disabling the network communications comprises launching a firewall outside of the confidential VM which prevents ingress and egress of network communications with respect to the confidential VM.

15. A computer program product comprising:
a set of one or more computer-readable storage media; and
program instructions, collectively stored in the set of one or more computer-readable storage media, for causing a processor set to perform computer operations comprising:
booting a confidential virtual machine (VM) based on a predefined image in response to a request from a software application, and disabling network communications into and out of the confidential VM;
mounting an encrypted disk inside the confidential VM based on the predefined image;
importing an encrypted machine learning (ML) model into the confidential VM based on the request from the software application;
importing a decryption key into the confidential VM and decrypting the encrypted ML model inside the confidential VM based on the decryption key;
importing a second decryption key into the confidential VM and decrypting the encrypted disk inside the confidential VM; and
launching a machine learning service with an executable instance of the encrypted ML model inside the confidential VM with an interface that enables the software application to input data to the executable instance of the encrypted ML model.

16. The computer program product of claim 15, wherein the computer operations further comprise receiving data from the software application via the interface, executing the encrypted ML model on the data utilizing the machine learning service to generate an output, and outputting the output from inside the confidential VM to the software application via the interface.

17. The computer program product of claim 15, wherein the booting comprises launching at least one selected from a group consisting of a confidential computing (CC)-enabled central processing unit (CPU) and a CC-enabled graphics processing unit (GPU), and enabling access to the CC-enabled CPU or the CC-enabled GPU from the machine learning service inside the confidential VM.

18. The computer program product of claim 15, further comprising mounting the encrypted disk inside the confidential VM based on the predefined image and storing the encrypted ML model inside the encrypted disk.

19. The computer program product of claim 15, wherein the booting comprises booting the confidential VM on an on-premises computing system with a gateway to a remote host platform where the software application is hosted, and the disabling the network communications comprises disabling the network communications at the gateway.

20. The computer program product of claim 15, wherein the booting comprises booting the confidential VM at a host platform where the software application is hosted, and the disabling the network communications comprises launching a firewall outside of the confidential VM which prevents ingress and egress of network communications with respect to the confidential VM.
